(19) United States
(12) Patent Application Publication
(10) Pub. No.: US 2013/0087957 A1
(43) Pub. Date: Apr. 11, 2013

(54) DEVICE FOR DAMPING THE VIBRATIONS IN A CRAWLER OR TRACKED VEHICLE

(71) Applicant: Rheinmetall Landsysteme GmbH, Kiel (DE)

(72) Inventors: Juergen RIEDL, Koenigsbrunn (DE); Hans MALL, Fuerstenfeldbruck (DE)

(73) Assignee: RHEINMETALL LANDSYSTEME GMBH, Kiel (DE)

(21) Appl. No.: 13/691,711

(22) Filed: Nov. 30, 2012

Related U.S. Application Data
(63) Continuation of application No. PCT/EP2011/002629, filed on May 27, 2011.

(30) Foreign Application Priority Data
May 31, 2010 (DE) DE102010022297.6

(51) Int. Cl. B62D 55/108

(52) U.S. Cl. CPC B62D 55/1083
USPC 267/285

(57) ABSTRACT

A device for damping vibrations acting upon a track vehicle is provided. Long torsion bar springs which so far have been used to absorb torsion are subdivided into a plurality of small torsion bar springs. The torsion bar springs are operationally interconnected via drive or transmission elements and accommodated outside the interior, thereby removing the need for installation space for the damping device at a right angle to and below the vehicle chassis, and reducing it to the lateral zone or inside a minor recess in the chassis, a so-called chassis recess.

This nonprovisional application is a continuation of International Application No. PCT/EP2011/002629, which was filed on May 27, 2011, and which claims priority to German Patent Application No. DE 10 2010 022 297.6, which was filed in Germany on May 31, 2010, and which are both herein incorporated by reference.

### BACKGROUND OF THE INVENTION

1. Field of the Invention

The invention relates to the damping of individual track rollers or track wheels or the track carriers of a crawler or tracked vehicle and proposes dividing long torsion bar springs used thus far into a plurality of small torsion bar springs to thereby reduce the installation space.

2. Description of the Background Art

DE 41 23 778 C2, which corresponds to U.S. Pat. No. 5,697,463, discloses efforts to dispose entire track components on a track carrier in the form of modules, which are connected together by tension and/or torque struts, which in turn are disposed below or above the bottom plate of the vehicle pan transverse to the longitudinal axis of the vehicle.

In a continuation of approaches of this type, it is proposed in EP 1 117 555 B2, which correspond to U.S. Pat. No. 6,527,072, that the entire drive unit is mounted in a corresponding side wall of the vehicle pan directly or via annular spacers, so that for the prior efforts an installation space is no longer needed below or above the bottom plate. The static components of the drive unit on their part are vibrationally uncoupled from the vehicle pan by vibration damping means. In practice this solution could not be accepted on a large scale.

Accordingly, parallel approaches are known from the state of the art to use hydraulic cylinders to transfer the damping in this way to the outside as well. Thus, DE 29 47 974 A1 discloses a stabilizing arrangement for a pan structure carried by a track drive of a tracked vehicle, whose hydraulic shock-absorbing means support the track rollers of the track drive.

A hydropneumatic element and the use in a vehicle with a drive and track rollers can also be derived from DE 103 28 541 A1, which is incorporated herein by reference.

Even when approaches are proposed, as to how to counteract the temperature development in such a cylinder, e.g., DE 10 2008 026 680 A1, or to provide movement-dependent damping, the temperature problem remains a functional problem.

### SUMMARY OF THE INVENTION

It is therefore an object of the invention to disclose a space-saving device for damping vibrations.

An embodiment of the invention is based on the idea of dividing the long, torsion-absorbing torsion bar springs into a plurality of smaller torsion bar springs. These are functionally connected to one another by drive or transmission elements and are accommodated outside the interior space. As a result, installation space for the damping device is no longer needed transverse to and below the vehicle pan, at most in the side region or within a small recess in the pan, a so-called pan niche.

The damping of the individual track rollers can be realized according to an embodiment by means of a torsion bar spring. In this regard, the spring is connected over the entire width of the vehicle pan torsionally rigid on the one side to the pan housing and on the other to the rotatably mounted support arm of the track roller. To achieve a torsion angle of about 100°, the length of the torsion bar springs is about 2-2.5 m. Because the torsion bar springs are placed above the pan bottom and protected by a cover (torsion bar tunnel), the usable height in the interior is considerably reduced thereby and has the result that access and the presence of a crew from a specific body height are only possible to a limited extent.

If a torsion (rotation) of 40° is to be absorbed, it is distributed to the individual torsion bars in such a way that, for example, in the case of four identical torsion bars each takes up 10° and in the case of, for example, five torsion bars each torsion bar or each torsion bar spring tube then takes up 8° of the rotation. Different torsion bars are also possible, however. Nevertheless, the advantage of identical, therefore equal torsion bars is that they absorb the rotation to the same degree and the rotation is thereby uniformly distributed.

The division of the torsion bar springs can occur in the form of a series connection, in the form of a parallel connection, and in combinations of both forms.

In an embodiment, this type of device is provided for each track roller. Alternatively, however, also the track carriers, which are arranged on the two side walls of the vehicle pan and receive the track components, are connected via devices of this type to the vehicle pan.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a torsion bar structure with a plurality of torsion bars disposed in parallel—stressed;

FIG. 2 shows the torsion bar structure of FIG. 1—unstressed;

FIG. 3 shows a schematic side view of the vehicle pan with the integrated device of FIG. 1;

FIG. 4 shows an illustration of a longitudinal torsion bar arrangement along the vehicle pan;

FIG. 5 shows a variant of the lengthwise torsion bar arrangement in the form of a series connection of a plurality of torsion bars—seen in a plan view in the direction of travel;

FIG. 6 shows the variant of FIG. 5 indicated in conjunction with the vehicle pan;

FIG. 7 shows a plan view of the divided torsion bars of FIG. 1;

FIG. 8 shows a plan view of the variant of whole or divided torsion bars integrated lengthwise;

FIG. 9 shows a plan view of the combination of the torsion bar integrations.

### DETAILED DESCRIPTION

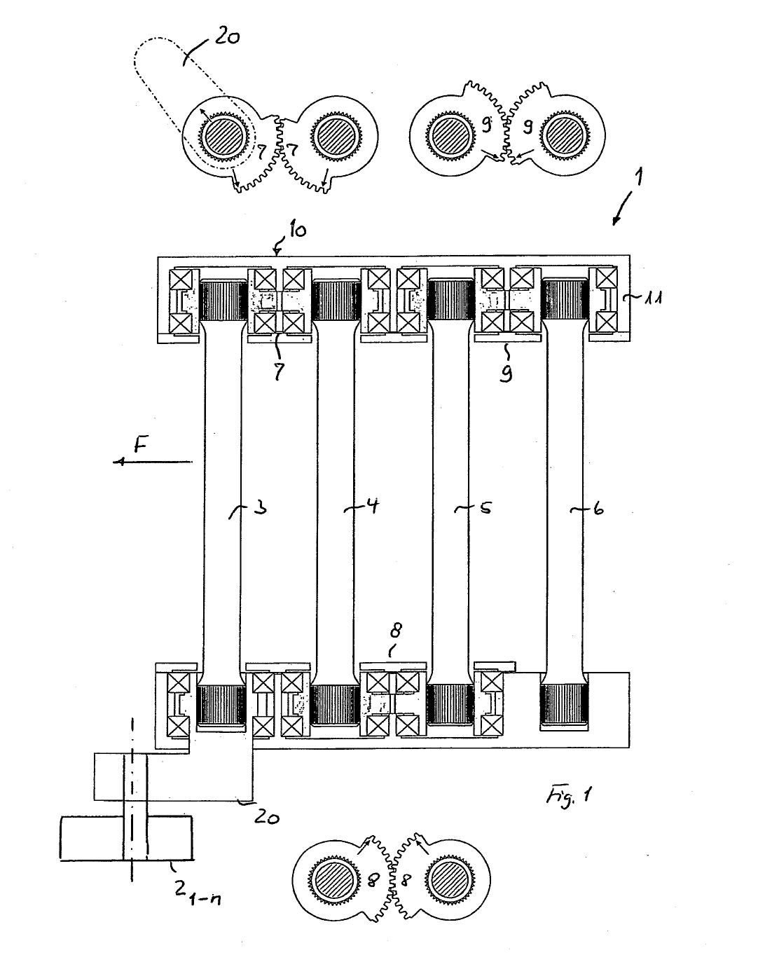

In FIG. 1, a device for damping vibrations of a track drive with a plurality of track rollers or wheels 2ₙ of a crawler or tracked vehicle (shown schematically in FIG. 3) is labeled with the number 1. Device 1 is connected, on the one hand, via support arms 20 to the specific track roller 2ₙ and, on the other, to vehicle pan 10 and has a plurality of at least two parallel torsion spring bars 3, 4 (5, 6), which can be functionally connected to one another via the drive or transmission component 7, 8 (9). The transmission or connection components 7-9 are freely selectable and can be, for example, toothed belts, gear wheels, lever mechanisms, chains, or the like. The illustration can be read in the direction of travel and in a plan view.

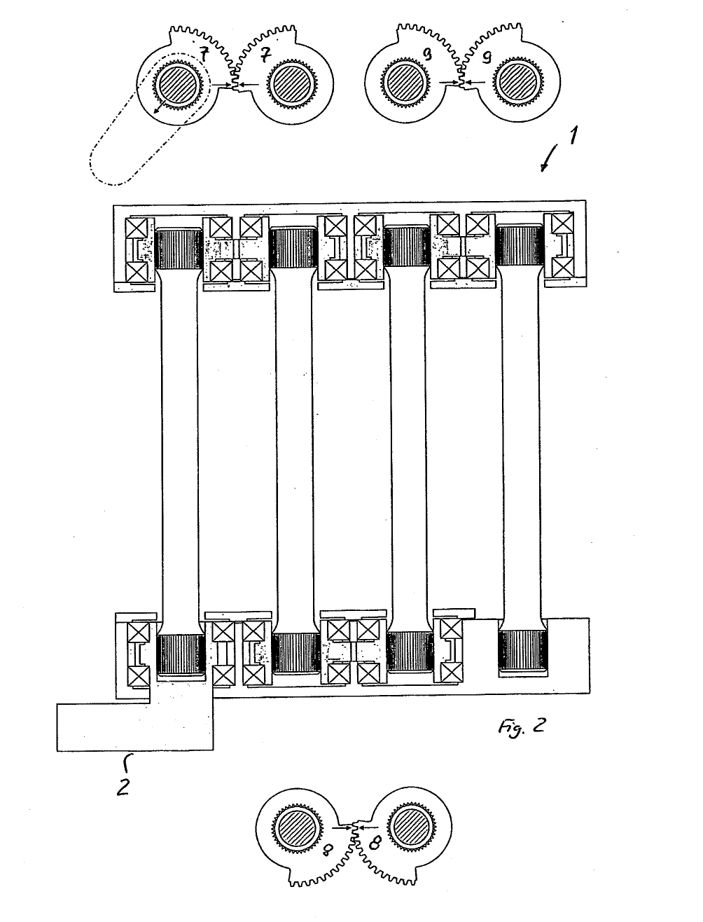

In FIGS. 1 and 2 the components 7-9 are gear wheel pairs. Torsion bar 3 is functionally connected via gear wheel pair 7 to torsion bar 4, which is functionally connected in turn via gear wheel pair 8 to torsion bar 5. Gear wheel pair 9 then connects torsion bar 6 to torsion bar 5. Each of these torsion bars 3-6 rotates due to this arrangement.

Torsion bar springs 3-6 are preferably identical in their lengths as well. If a track roller 2 was dampened thus far via a 2000 mm-long torsion bar spring, which allowed a torsion angle of 100°, now, for example, four identical torsion bars 3-6 with a length of, for example, 550 mm are integrated in the novel device 1. The last torsion bar 6 is mounted in pan housing 11. Each torsion bar spring 3-6 for its part then takes up a rotation of 25°. Variable and thereby different lengths of torsion bars 3-6 are likewise possible, but because of connection components 7-9 of torsion bars 3-6 among one another then increase the structural design, when these torsion bars 3-6 are oriented exclusively parallel to one another. The transmission component 7-9 in FIG. 1 are stressed. FIG. 2 shows the same device 1 in which transmission components 7-9 are unstressed.

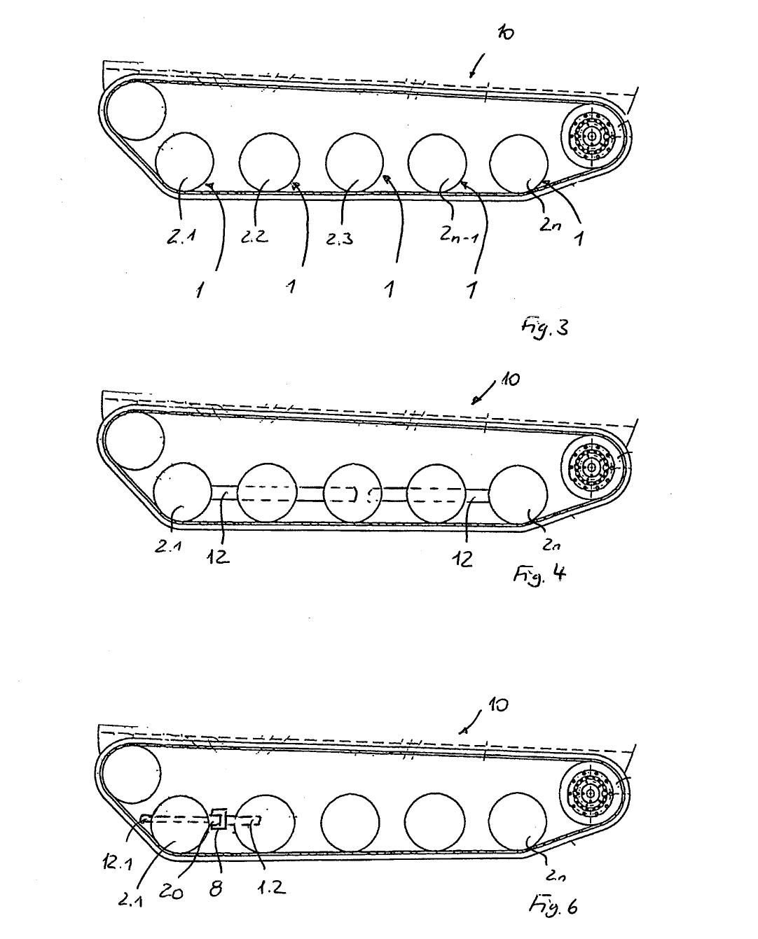

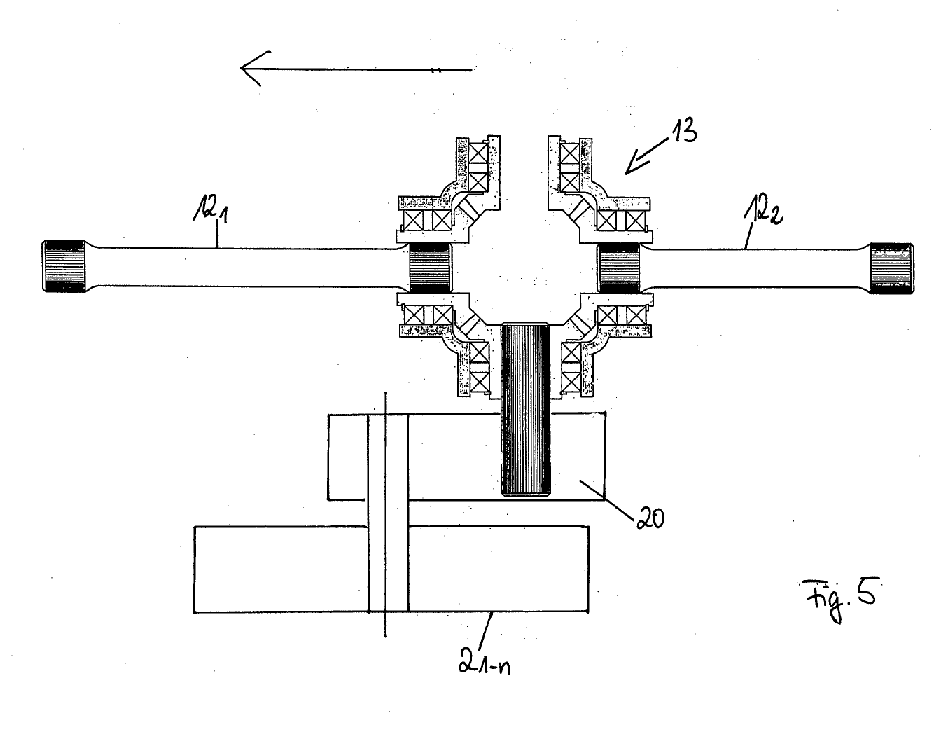

Particularly for the first 2₁ and last wheel 2ₙ, alternatively a lengthwise integrated torsion bar 12 (torsion bar spring) can be used as device 1′, which is attached lengthwise in the direction of travel (FIG. 4). In this case, the damping of the first 2₁ and last wheel 2ₙ (depending on the length of pan 10) and also of the second or next-to-last wheel can be taken up via one torsion bar 12 each, whose torsion movement is started via the previously mentioned transmission compononent. Torsion bar 12 can also be divided, however, as illustrated in FIG. 5. The division of the lengthwise integrated torsion bars 12 in this case occurs into a plurality of bars 12₁, 12₂, whereby a series connection manner is preferred. Torsion bars 12₁ to n for their part are then functionally connected to one another by means of transmission elements 13. An integration in vehicle pan 10 is shown merely vaguely for a general visualization of the idea.

It should be pointed out only for the sake of completeness that the last described division lengthwise along the vehicle pan 10 can also be utilized for the intermediate wheels 2₂ to 2ₙ-₁.

Depending on the space requirement, the torsion bars can thereby be arranged as already described in a series connection, parallel connection, and also combined in a parallel and series connection. The integration of device 1 and of torsion bars 12 as a whole and divided 12₁, 12₋ₙ can be combined.

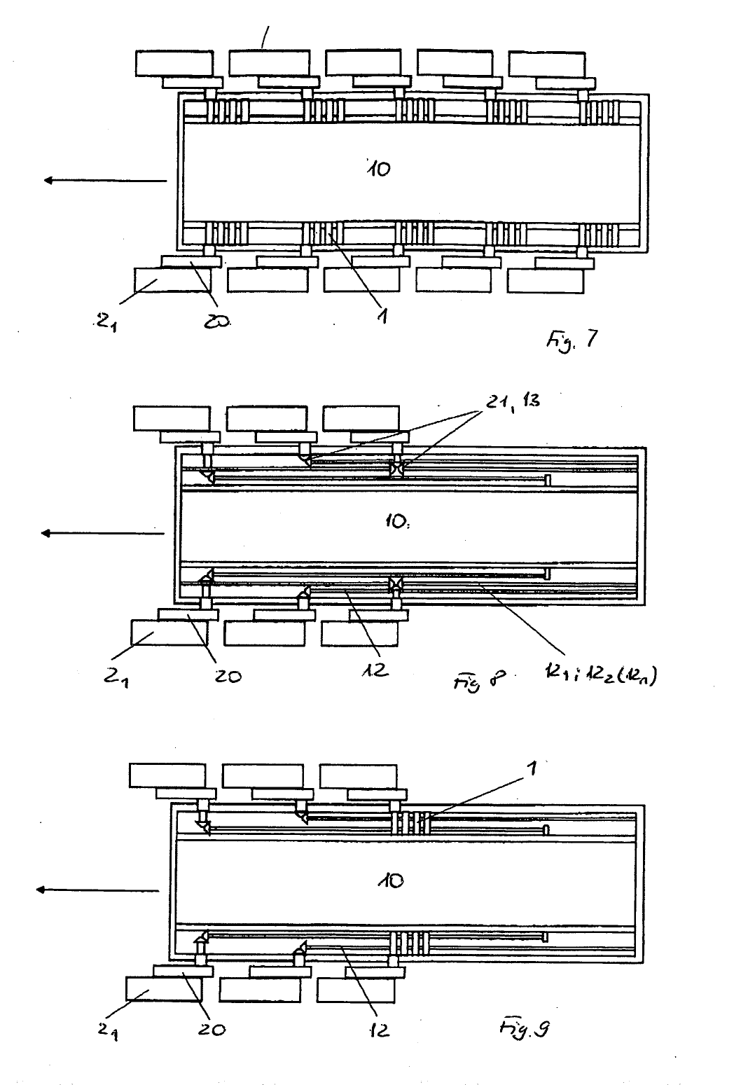

FIGS. 7 to 9 show the different variants and options in a plan view. There are in each case a transmission element 13 and/or angle gear 21 between the torsion bars and the support arms.

In an alternative variant, device 1 can be integrated on both sides of vehicle pan 10 and similar to DE 41 23 778 C2 take over the task of the tension and/or torque struts, so that device 1 is not functionally connected to the individual track rollers 2 but to the modules merged to form the track carriers, placed on both sides on the vehicle pan, and absorbs the vibrations (not shown in greater detail).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for damping vibrations of a track-laying or tracked vehicle via torsion or torsion spring bars, the device comprising at least two smaller or shorter torsion spring bars that are oriented with respect to a vehicle pan and are functionally connected to one another via a drive and/or transmission elements.

2. The device according to claim 1, wherein the torsion spring bars are arranged in series and/or parallel to one another.

3. The device according to claim 1, wherein the first torsion spring bar is attached to a support arm of a track roller and the last torsion spring bar is mounted in or on the pan housing.

4. The device according to claim 1, wherein the first torsion spring bar is mounted on the track carrier and the last torsion spring bar in or on the pan housing.

5. The device according to claim 1, wherein the drive and/or transmission elements are freely selectable and are toothed belts, gear wheels, lever mechanisms, or chains.

6. The device according to claim 1, wherein the torsion spring bars are substyantially identical or variable in their length.

7. The device according to claim 1, wherein the torsion spring bars are different in their length.

8. The device according to claim 1, wherein the torsion spring bars are integrated on an outside at and/or in a side niche in the vehicle pan.
